(19) United States
(12) Patent Application Publication
(10) Pub. No.: US 2004/0057342 A1
(43) Pub. Date: Mar. 25, 2004

(54) Watch photo dial plate

(76) Inventor: Feng-Lung Chang, Taipei (TW)

Correspondence Address: Elliott N. Kramsky, Esq., Suite 400, 5850 Canoga Avenue, Woodland Hills, CA, 91367, US

(21) Appl. No.: 10/320,192

(22) Filed: Dec. 16, 2002

(30) Foreign Application Priority Data
Sep. 19, 2002 (TW) 091214808

(51) Int. Cl. G04B 19/06

(52) U.S. Cl. 368/232

(57) ABSTRACT

The present invention relates to a photo dial plate for a watch. The photo dial plate for a watch according to the present invention is prepared by covering the photo with a laminate film, cutting a laminated photo into a shape same as a watch frame, then fixing the laminate-covered photo into the watch by installing watch hands thereupon. The watch having the photo dial plate thus formed is different from a traditional dial plate and is much more artistic and commemoratory. Further, the photo is not easy to be deteriorated even the watch is worn for a long time.

### FIELD OF THE INVENTION

The present invention relates to a watch photo dial plate. In particular, the present invention relates to a photo dial plate for a watch, in which a photo covered with a laminate is cut into a shape and size same as a watch frame, and then, is fixed on the dial plate through the installment of watch hands.

### TECHNICAL BACKGROUND

A watch dial plate is conventionally made from an alloy. There are usually no patterns and designs on the surface of the plate in addition to the hour numerals and the indices. Thus, appearance of the watch is too simple to be esthetic. Under the circumstances, it cannot satisfy the people who run after diversification and fashion.

### OBJECTS OF THE PRESENT INVENTION

The present invention relates to a photo dial plate for a watch. The photo dial plate of the present invention is prepared by the steps of covering a photo with a laminate film, cutting the laminated photo into a shape and size same as a watch frame, punching a hole in the cut laminated photo at its center, fixing the cut laminated photo by installing hour and minute hands in a watch stem so as to be a dial plate.

Therefore, one of the objects of the present invention is to provide a photo dial plate for a watch, used to display a memorial photo.

Another object of the present invention is to provide a memorial photo dial plate for a watch, in which the memorial photo is covered by laminate film so that the photo is hardly deteriorated and always remains new.

These objects and the other objects, features, and advantages will be apparent to those people skilled in the art from the following detailed description in connection with the drawings.

### BRIEF DESCRIPTION OF THE DRAWINGS

FIG. 1a shows a schematic view of a photo before being covered with a laminate film;

FIG. 1b shows a schematic view of a photo after being covered with a laminate film;

FIG. 1c shows a schematic view of a photo dial plate for a watch according to the present invention;

FIG. 2 shows an explosion view of a watch having the photo dial plate according to the present invention;

FIG. 3 shows a schematic view of a finished watch assembled with a photo dial plate according to the present invention.

### DETAILED DESCRIPTION OF THE PRESENT INVENTION

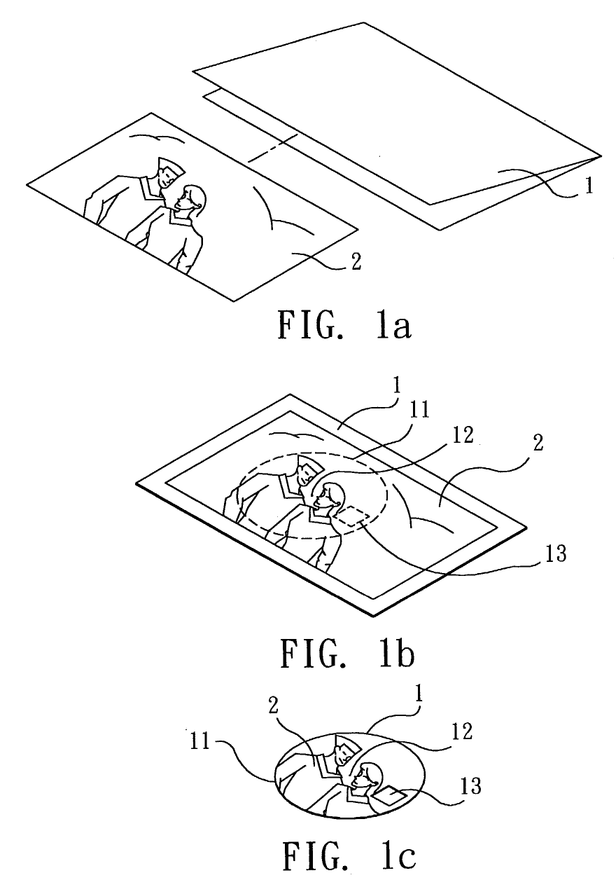

Now please refer to FIGS. 1a, 1b, and 1c, these figures show the procedures for preparing a photo dial plate according to the present invention. FIG. 1a shows a first step that a laminate film 1 is used to cover wholly at the top and bottom sides of a selected photo 2 (the photo is developed from a film, or printed from a laser printer or inkjet printer). FIG. 1b shows a second step that the laminated photo 2 (the thickness of the laminated photo is equal to or close to the thickness of a conventional dial plate) is cut into a circle plate 11 same as a watch frame, and then, a central hole 12 and a date display hole 13 are punched. In this case, although the watch frame is a circle shape, but the photo can be cut in any shape for different kinds of watches. A finished photo dial plate is shown in FIG. 1c.

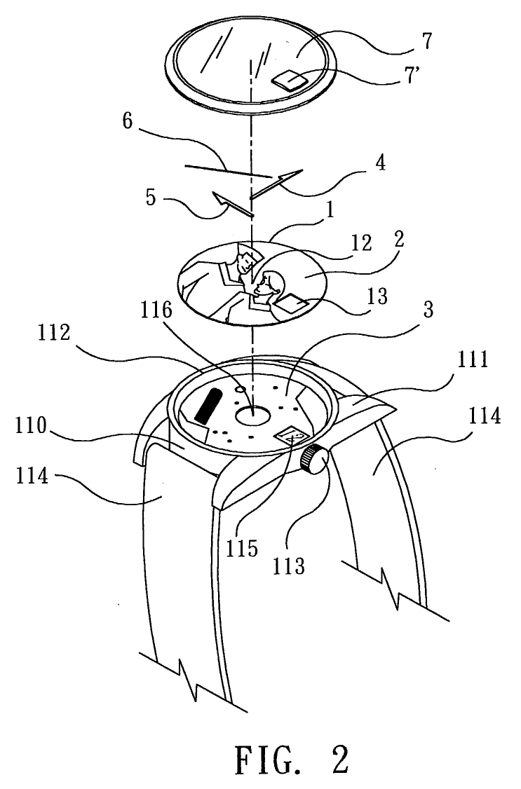

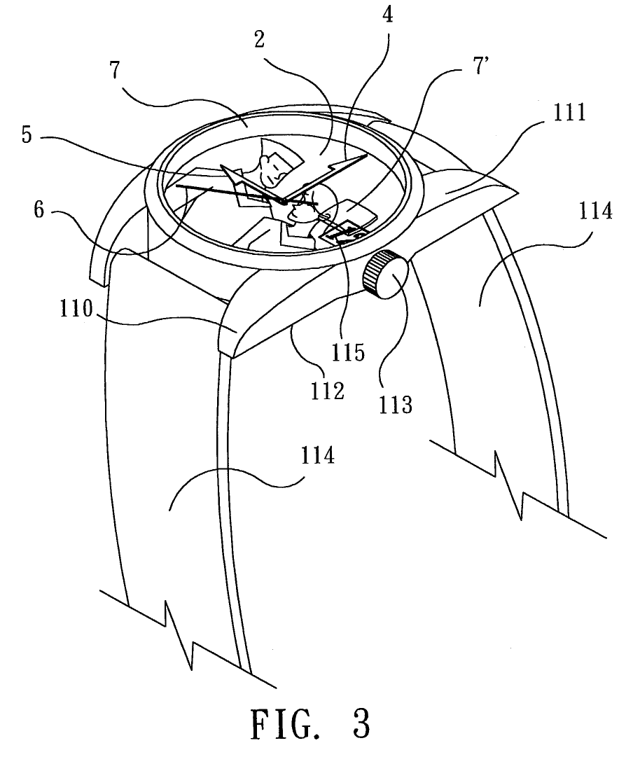

Now please refer to FIG. 2. FIG. 2 shows an explosion view of a watch having a photo dial plate installed thereon according to the present invention. From FIG. 2, it is obvious that the watch mainly consists of a movement 3, body 110, case 111, housing 112, crown 113, watchband 114, date display frame 115, laminated photo 2, hour hand 5, minute hand 4, second hand 6, andcovering glass 7. Besides, a stem 116 is provided at the center of the movement 3 for driving the hour, minute, and second hands to rotate around it. In some watches, a magnifying glass 7′ is provided on the watch glass 7 for magnifying the date displayed in the watch. While installing the watch, the central hole 12 of the photo 2 is aimed at the stem 116 and the date display hole 13 is aimed at the date display frame 115. If necessary, the laminated photo 2 is fixed on the movement 3 in aid of adhesive. And then, the hour hand 5, the minute hand 4 and the second hand 6 are installed in the stem 116 to fix the laminated photo 2 below them on the watch. Finally, the covering glass 7 is disposed on the watch housing 112 in which the magnifying glass 7′ is aimed at the date display frame 115. Here, detail on the technique for installing a watch is well known to those skilled in the art and no further illustration is needed. The finished watch is shown in FIG. 3.

Since a user can choice can choose his favorite photo to use in the present invention, watches having a photo dial plate according to the present invention possess a artistic appearance and could be taken as a commemorative article. Further, a photo dial plate for a watch has not been suggested nor found in prior art and is new.

Although the present invention has been described by the above embodiment, the present invention is not limited by the embodiment. Person skilled in the art would make various changes or modification without departing from the spirit and the scope of the present invention. The present invention is only limited by the appended claims.

What is claimed is:

1. A photo dial plate for a watch, prepared by cutting a photo into a shape and size same as a watch frame and fixing said photo in said watch to be a dial plate.

2. The photo dial plate according to claim 1, wherein the photo is first covered with a laminate film before cut into said shape and size.

3. The photo dial plate according to claim 1 wherein said cut photo is punched a hole at a center thereof.

4. The photo dial plate according to claim 3, wherein said cut photo is punched a hole therein for showing date.

5. The photo dial plate according to claim 3, wherein said cut photo is fixed on said watch by installing a hour hand, a minute hand, and a second hand in a stem used to drive said hands.

6. The photo dial plate according to claim 5, wherein said cut photo is fixed on the watch by applying adhesive on rear side thereof.
